(19) United States
(12) Patent Application Publication
(10) Pub. No.: US 2012/0027203 A1
(43) Pub. Date: Feb. 2, 2012

(54) INTERFACE CIRCUIT

(75) Inventor: Hirofumi Inada, Kyoto (JP)

(73) Assignee: ROHM CO., LTD., Kyoto (JP)

(21) Appl. No.: 13/188,726

(22) Filed: Jul. 22, 2011

(30) Foreign Application Priority Data
Jul. 27, 2010 (JP) JP2010-168282

(51) Int. Cl. H04L 9/18

(52) U.S. Cl. 380/42

(57) ABSTRACT

A decoder extracts a synchronization signal from a data stream received via an active port. Synchronization signal generators are arranged for respective ports, and each is configured such that, when it receives a synchronization signal for the corresponding port from the decoder, it cyclically generates a replica of the synchronization signal for the port. When the synchronization signal received from the decoder or the synchronization signal generator is asserted, a first calculation module calculates authentication data. When the synchronization signal for the active port is asserted, a second calculation module generates a decipher code used to decipher the data stream input to the active port, using data obtained by the calculation processing of the first calculation module.

### BACKGROUND OF THE INVENTION

1. Field of the Invention

The present invention relates to an interface circuit configured to decrypt encrypted data.

2. Description of the Related Art

Multimedia devices such as televisions and audiovisual amplifiers each have multiple channels of input interfaces, and a selector, which allows multiple devices to be connected to such a multimedia device. Furthermore, such an arrangement is capable of performing processing of a data stream received from a device connected to any one of the channels selected by the selector.

In recent years, as an interface for such a multimedia device, the HDMI (High-Definition Multimedia Interface) standard or the DVI (Digital Visual Interface) standard have become widely used. With the HDMI standard or the DVI standard, after authentication of the connection between the mutually connected devices, an encrypted data stream, such as video data, audio data, or the like, is transmitted.

### RELATED ART DOCUMENTS

### Patent Documents

### [Patent Document 1]

International Publication WO 09/108,818 pamphlet

### [Patent Document 2]

Japanese Patent Application Laid Open No. 2001-127754

### [Patent Document 3]

Japanese Patent Application Laid Open No. 2007-89013

Patent document 1 discloses a circuit configuration configured to receive encrypted data streams from multiple external devices (source devices), to select one of the data streams thus received, and to output the data stream thus selected. With such a technique, as shown in FIG. 2, HDCP (High-bandwidth Digital Content Protection) engines (104, 106, 108, and 109) are provided for the respective source devices. From among the decryption codes (cipher outputs) generated by the respective HDCP engines, a multiplexer (102) selects one that corresponds to an active port. A decipher engine (256) uses the decryption data thus selected to decrypt video data and packet data received via the active port.

With such a technique disclosed in Patent document 1, such an arrangement requires an HDCP engine for each input port. Accordingly, as the number of ports becomes greater, the hardware scale also becomes greater.

### SUMMARY OF THE INVENTION

The present invention has been made in order to solve such a problem. Accordingly, it is an exemplary purpose of the present invention to provide a reduction in the circuit area of an interface circuit having multiple ports.

An embodiment of the present invention relates to an interface circuit configured to receive encrypted data streams from multiple external devices via multiple ports thereof, to decipher the encrypted data stream input to the active port, and to output the data stream thus deciphered. The interface circuit comprises multiple ports, a selector, multiple synchronization signal generators arranged for the respective ports, a first calculation module, a second calculation module, a decryption module, and an authentication unit.

The multiple ports are connected to the respective external devices. Each port comprises an input port configured to receive, as input data, an encrypted data stream from the corresponding external device, and an authentication port configured to transmit/receive a signal required to perform authentication between it and the corresponding external device. The selector is configured to select the data stream input to the active port among the multiple input ports. The decoder is configured to receive the data stream input to the active port selected by the selector, and to extract a synchronization signal. Each synchronization signal generator is configured to cyclically generate a synchronization signal for the corresponding port after it receives a synchronization signal for the corresponding port from the decoder. The first calculation module is configured such that, when the synchronization signal extracted by the decoder is asserted for the active port, or when the synchronization signal generated by the synchronization signal generator is asserted for an inactive port, it calculates authentication data used to establish and maintain a link between the port and the corresponding external device. The second calculation module is configured such that, when the synchronization signal is asserted for the active port, it generates a decipher code used to decipher the data stream input to the active port, using data obtained by the calculation processing of the first calculation module. The decryption module is configured to decrypt the data stream input to the active port selected by the selector, using the decipher code output from the second calculation module. The authentication processing unit is configured to maintain a link between each port and the corresponding external device, using the authentication data calculated for the corresponding port by the first calculation module.

Once a given port is set to be the active port, even after the port thus set to be the active port is set to be an inactive port, a synchronization signal related to this port can be generated as an internal signal by means of the synchronization signal generator. Furthermore, such an arrangement is capable of generating, by means of the first calculation module, the authentication data required to establish links between the multiple ports and the respective external devices. Accordingly, authentication can be maintained between the external device and a port once the port is set to be the active port, even during a period in which the port is set to be an inactive port, using the synchronization signal generated as an internal signal and the authentication data. Thus, such an arrangement allows reestablishing the authentication to be omitted when the port is again set to be the active port. Furthermore, there is no need to increase the number of calculation modules even if the number of ports is increased. Thus, such an arrangement suppresses an increase in the circuit area.

Also, the data received from the external device may include image data or audio data. Also, the first calculation module may be configured to execute calculation processing for every frame. Also, the second calculation module may be configured to execute calculation processing for every pixel.

Another embodiment of the present invention relates to an electronic device. The electronic device comprises the aforementioned interface circuit.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram which shows a configuration of an electronic device including an interface circuit according to an embodiment;

FIGS. 2A through 2F are diagrams showing the operations of a first calculation module and a second calculation module;

FIG. 3 is a time chart related to an active port of the interface circuit shown in FIG. 1; and

FIG. 4 is a time chart which shows an authentication operation of the interface circuit shown in FIG. 1 for multiple ports.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

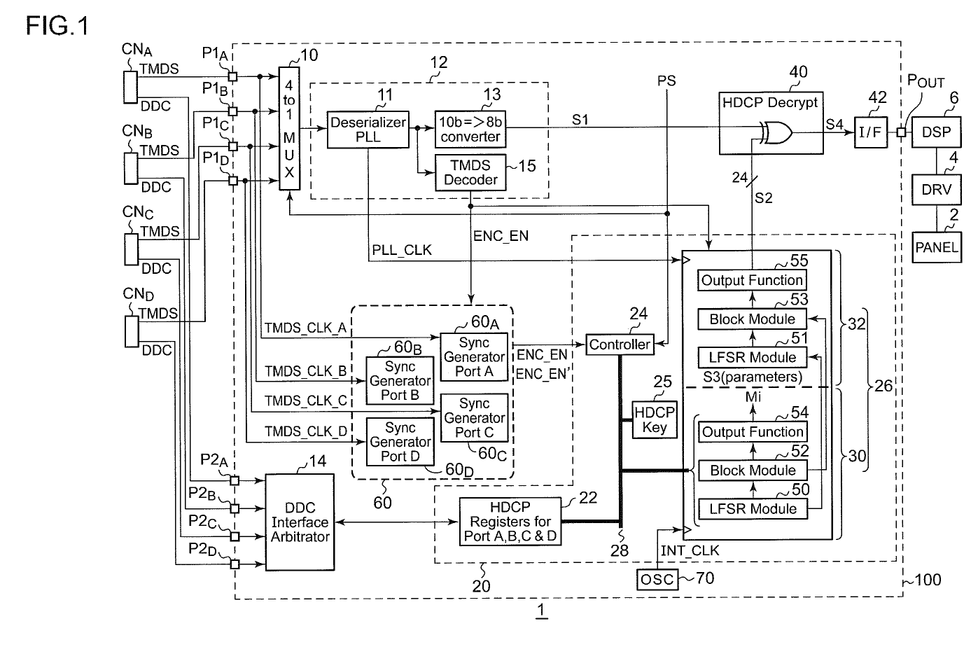

FIG. 1 is a block diagram which shows a configuration of an electronic device 1 including an interface circuit 100 according to an embodiment. Examples of such an electronic device 1 include multimedia devices such as a television including multiple input ports, a PC display, an audiovisual amplifier, and a digital video recorder. However, the usage of the interface circuit 100 is not restricted in particular. For example, the electronic device 1 may be configured as an HDMI selector. Description will be made in the present embodiment regarding an arrangement in which the electronic device 1 is configured as a display apparatus.

The electronic device 1 is configured to be connected to an external device (not shown) via a multimedia interface, to receive video data or audio data (which will be collectively referred to as “content data”) from the external device, and to display and play back the data thus received. Examples of such a multimedia interface include the HDMI standard, the DVI standard, the display port standard, the VGA standard, etc. It should be noted that the interface standard is not restricted to such standards. Rather, various kinds of known or prospectively proposed standards may be employed, providing that the standard requires authentication before data transmission.

Description will be made below regarding an interface circuit 100 that conforms to the HDMI standard, for ease of understanding.

The electronic device 1 includes multiple connectors CN_{A} through CN_{D}, which allow external devices to be detachably connected via the respective connectors. Although the number of connectors CN is not restricted in particular, the present invention in particular is suitably applied to an arrangement including three or more connectors. The electronic device 1 displays video data (image data) received from the external device connected to one connector (port) selected by the user. In the present specification, the port to be processed by the electronic device 1 will be referred to as the “active port”, and the ports other than the active port will each be referred to as an “inactive port”. The active port is selected by the user of the electronic device 1.

The electronic device 1 includes a display panel 2, a panel driving unit 4, a DSP 6, and an interface circuit 100.

The interface circuit 100 receives data streams input from external devices via the multiple connectors CN_{A} through CN_{D}, selects the data stream from the external device connected to the connector CN that is set to be the active port, decrypts the encrypted data stream, and outputs the data stream thus decrypted via the output port P_{OUT}.

The DSP 6 performs predetermined signal processing on the output data D_{OUT} received from the interface circuit 100, and outputs the output data thus subjected to the signal processing to the panel driving unit 4. The panel driving unit 4 drives the display panel 2 according to the output data D_{OUT} thus received.

The above is the overall configuration of the electronic device 1. Next, detailed description will be made regarding the interface circuit 100 according to the embodiment.

The aforementioned multimedia interface is required to be authenticated before data transmission. The interface circuit 100 is configured to perform the authentication, in addition to data transmission/reception between the interface circuit 100 and the external devices.

With the HDMI standard, a system is configured including source devices, a sink device, and cables. In the present specification, the electronic device 1 corresponds to a sink device, and the external devices each correspond to a source device. Video data and audio data are transmitted from each source device to the sink device using the TMDS (Transition Minimized Differential Signaling) method. Authentication of the source device and the sink device is performed after information (display data) such as the manufacturer of the display, its model number, its resolution, etc., is transmitted/received between the source device and the sink device via a DDC (Display Data Channel) line.

With the HDCP standard, first, in the so-called “authentication first part” (which will be referred to as the “first authentication” hereafter), authentication of the source device and the sink device is performed, and a link is established between them. Specifically, the source device issues an authentication request to the sink device, and data required for authentication is transmitted/received between the sink device and the source device. If establishing a link fails, after a predetermined period of time elapses, the source device again issues an authentication request to the device to be linked.

Once the link is established between the source device and the sink device, the link is maintained by means of the so-called “authentication third part” (which will be referred to as the “third authentication” hereafter). Specifically, the source device outputs, to the sink device, a synchronization signal (an encryption enable signal, which is a notice that the data is encrypted frame data) ENC_EN synchronized to the frame, and instructs the sink device to check the link state every cycle, e.g., every 128 frames. Specifically, the synchronization signal ENC_EN or ENC_DIS is positioned 528 pixel clocks after the vertical synchronization signal VSYNC. The sink device responds to the link check from the source device using the synchronization signal ENC_EN as a trigger.

The interface circuit 100 includes multiple input ports P1_{A} through P1_{D}, multiple authentication ports P2_{A} through P2_{D}, a selector 10, a decoder 12, a DDC interface unit (authentication processing unit) 14, a decipher unit 20, a decryption module 40, an output interface unit 42, multiple synchronization signal generators 60_{A} through 60_{D}, and an oscillator 70.

Data streams are input to the multiple input ports P1_{A} through P1_{D} from the multiple external devices. The data streams include video data, audio data, and so forth. Furthermore, the multiple authentication ports P2_{A} through P2_{D} are respectively connected to DDC lines which are each configured as an HDMI cable. The signals required for authentication between the external devices (source devices) and the interface circuit 100 are transmitted/received between them via the authentication ports P2. The transmission protocol used via the DDC line conforms to the I₂C (Inter IC) bus protocol. It should be noted that, although the HDMI standard employs a CEC (Consumer Electronics Control) line, in addition to a DDC line and a TMDS line, description of the CEC line will be omitted. A set of a single input port P1, a corresponding authentication port P2, and a corresponding CEC port are connected to a single corresponding connector CN so as to form a port.

The selector 10 selects the data stream input to the one of the multiple input ports P1_{A} through P1_{D} that has been set to be the active port, and outputs the data stream thus selected.

The decoder 12 receives the data stream D_{ACT} received via the active port, which is output from the selector 10, and extracts the horizontal synchronization signal HSYNC, the vertical synchronization signal VSYNC, video data, packet data, and the synchronization signals ENC_EN and ENC_DIS from the data stream D_{ACT} thus received.

Specifically, the decoder 12 includes a de-serializer 11, a format converter 13, and a TMDS decoder 15. The de-serializer 11 receives a data stream configured as serial data, reproduces the PLL clock PLL_CLK, and converts the data stream into parallel data. The PLL clock is also referred to as the “pixel clock”. With the TMDS method, the data stream is subjected to 8b/10b encoding, and the data stream thus encoded is transmitted. With such an arrangement, the format converter 13 decodes the data stream thus subjected to 8b/10b encoding. The TMDS decoder 15 extracts the horizontal synchronization signal HSYNC, the vertical synchronization signal VSYNC, the video data, the packet data, and the synchronization signals ENC_EN and ENC_DIS, from the data stream D_{ACT} received via the active port selected by the selector 10.

The synchronization signal generators 60_{A} through 60_{D} are arranged for the respective ports. The synchronization signal ENC_EN received from the decoder 12 is input to the one of the synchronization signal generators 60_{A} through 60_{D} that corresponds to the active port. The synchronization signal generator 60ᵢ (i represents one of A through D) that receives the synchronization signal ENC_EN holds the properties of the synchronization signal ENC_EN, and generates a replica of the synchronization signal (a signal that emulates the synchronization signal) ENC_EN′ that has the same properties as those of the synchronization signal ENC_EN using the TMDS clock TMDS_CLK received via the corresponding port. The synchronization signal generator 60ᵢ continues to generate the synchronization signal ENC_EN′ even after the corresponding port is switched to being an inactive port.

With regard to the active port, the synchronization signal ENC_EN output from the decoder 12 is supplied to the decipher unit 20. With regard to an inactive port, the emulated synchronization signal ENC_EN′ generated by the synchronization signal generator 60 is supplied to the decipher unit 20.

The decipher unit 20 includes a register 22, a multiport control unit 24, memory 25, a decipher code generating unit (HDCP Cipher) 24.

The multiport control unit 24 performs processing related to switching the multiple ports. The multiport control unit (multiport control engine) 24 receives, as an input signal, data (port select data PS) which indicates the active port. According to the port select data PS, the selector 10 selects the data stream output from the active port. Furthermore, the multiport control unit 24 controls the decipher code generating unit 26, and instructs the decipher code generating unit 26 to execute operations required for the respective ports. The register 22, the multiport control unit 24, the memory 25, and the decipher code generating unit 26, are connected to each other via a bus 28.

The memory 25 stores an HDCP key. The decipher code generating unit 26 generates a code (hdcpBlockCipher: Rᵢ) required to establish and maintain the links between the electronic device 1 and the multiple external devices, and generates a decipher code (hdcpStreamCipher and hdcpRekeyCipher) S2 required to decipher the encrypted data stream input via the active port.

The decipher code generating unit 26 largely executes the following three kinds of operations.

1. hdcpBlockCipher

In the first authentication (authentication first part: at authentication), the decipher code generating unit 26 generates a session key Ks, and outputs data R₀ and M₀. Furthermore, in the third authentication (authentication third part: at vertical blank), the decipher code generating unit 26 outputs a frame key Kᵢ, authentication data (HDCP cipher outputs) rᵢ, and an authentication key (integrity verification key) Mᵢ for every synchronization signal ENC_EN, i.e., for every frame. The authentication data rᵢ is output as authentication data (link synchronization verification values) Rᵢ every 128 frames, and are used to perform authentication of the external device.

2. hdcpStreamCipher

The decipher code generating unit 26 generates a decipher code S2 to be input to the decryption module 40 for the video data and the packet data for every respective pixel.

3. hdcpRekeyCipher

After one line of video data is received, the decipher code generating unit 26 generates Rekey data.

The decipher code generating unit 26 includes a first calculation module 30 and a second calculation module 32.

The first calculation module 30 executes calculation processing related to the hdcpBlockCipher for every frame for each port, so as to generate the session key Ks and the frame key Kᵢ.

The multiport control unit 24 monitors the synchronization signals ENC_EN and ENC_EN′ supplied from the synchronization signal generator 60. The synchronization signals ENC_EN and ENC_EN′ are asserted for every frame for each port. When the synchronization signal ENC_EN extracted by the decoder is asserted with respect to the active port, or when the synchronization signal ENC_EN′ generated by the synchronization signal generator 60 is asserted with respect to the inactive port, the multiport control unit 24 instructs the first calculation module 30 to generate authentication data (link synchronization verification values) rᵢ required to establish, and thereafter to maintain, a link with the external device that corresponds to the port. That is to say, when the synchronization signal ENC_EN or ENC_EN′ is asserted for a given port, the first calculation module 30 generates the authentication data rᵢ for this port.

The session key Ks and the frame key Kᵢ thus generated for every frame for each port are stored in the register.

The authentication data Rᵢ′ is generated every 128 frames using the frame key Kᵢ thus generated for each port. The authentication data Rᵢ′ thus generated is used by the source device connected to the corresponding port to access the sink device and to maintain authentication.

Furthermore, the first calculation module 30 outputs, to the second calculation module 32, a parameter S3 which is a parameter generated in the course of calculation processing related to the active port, and which is required to perform calculation processing related to the hdcpStreamCipher and hdcpRekeyCipher.

When the synchronization signal ENC_EN is asserted for the active port, the second calculation module 32 uses the parameter S3 received from the first calculation module 30 to perform calculation processing related to the hdcpStreamCipher for every pixel for the active port, and to execute calculation processing related to the hdcpRekeyCipher for every line for the active port.

That is to say, there is a difference in the operating speed between the first calculation module 30 and the second calculation module 32. Specifically, the first calculation module 30 operates in synchronization with a 133 MHz internal clock INT_CLK, and the second calculation module 32 operates in synchronization with the pixel clock PLL_CLK for the active port. The internal clock INT_CLK is generated by the oscillator 70.

The first calculation module 30 and the second calculation module 32 have the same configuration. The first calculation module 30 includes an LFSR module 50, a block module 52, and an output unit (output mechanism) 54. In the same manner, the second calculation module 32 includes an LFSR module 51, a block module 53, and an output unit 55.

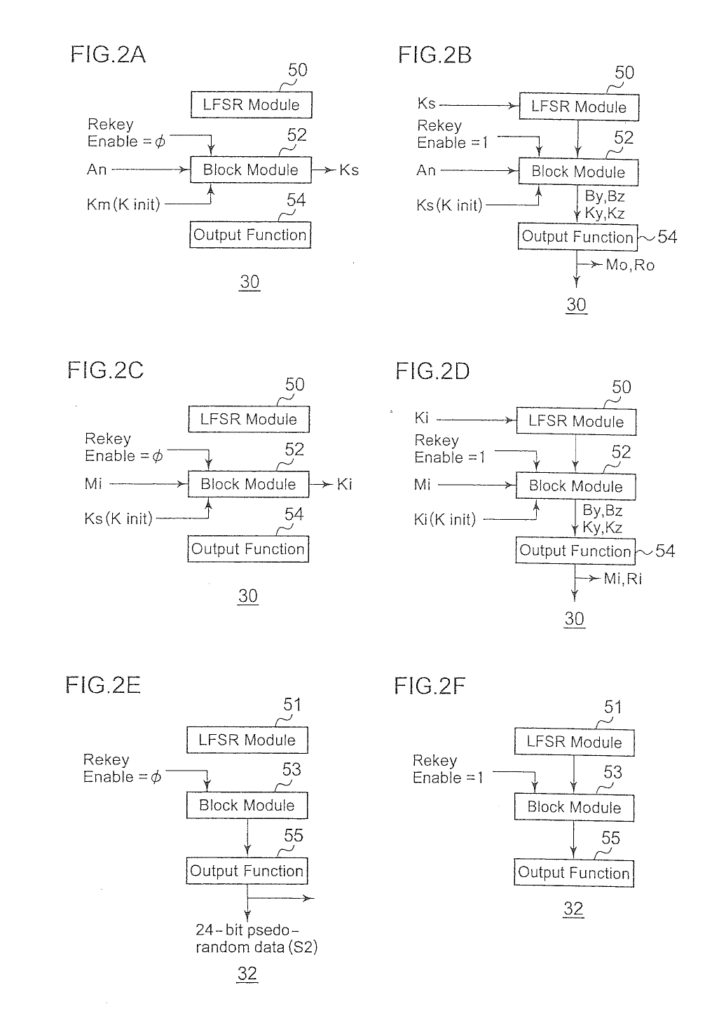

Description will be made regarding each step of the operations of the first calculation module 30 and the second calculation module 32. FIGS. 2A through 2F are diagrams showing the operations of the first calculation module 30 and the second calculation module 32. The operations of the LFSR module 50 (51), the block module 52 (53), and the output unit 54 (55) conform to the HDCP protocol (“High-bandwidth Digital Content Protection System Revision 1.4”, Digital Content Protection LLC, Jul. 8, 2009). Accordingly, for a detailed description thereof, we refer to the aforementioned HDCP protocol. Here, directing attention to such a configuration thus divided into two modules, that is, the first calculation module 30 and the second calculation module 32, description will be made regarding the operation of these modules.

(I) hdcpBlockCipher

(I-1) First authentication (authentication first part: at authentication)

FIG. 2A shows the operation state when the first calculation module 30 generates the session key Ks in the first authentication.

1-a) Rekey signal is disabled.

1-b) A pseudo-random value is set to An. A value REPREATER∥An is loaded into the B register of the block module 52 as an initial value, and a secret value Km is loaded into the K register of the block module 52 as an initial value.

1-c) 48 clocks are supplied to the block module 52.

1-d) The session key Ks[83:0] is generated in the B register of the block module 52.

FIG. 2B shows the operating state when the first calculation module 30 outputs the data R₀ and M₀ in the first authentication.

1-e) The session key Ks generated in a previous step is loaded into the K register of the block module 52.

1-f) The value REPEATER∥An is loaded into the B register of the block module 52.

1-g) The LFSR module 50 is initialized using the session key Ks.

1-h) The Rekey signal is enabled, and 56 clocks are supplied to the LFSR module 50 and the block module 52. The output unit 54 generates the code M₀ during the last four clocks, and generates the code R₀ during the last two clocks. The codes M₀ and R₀ thus generated are held.

(I-2) Third authentication (authentication third part: at vertical blank)

FIG. 2C shows the operating state when the first calculation module 30 generates the frame key Kᵢ in the third authentication. The index i represents a variant that is incremented with every frame. The first calculation module 30 executes the following processing for each port for every assertion of the synchronization signal ENC_EN (or ENC_EN′).

2-a) The initial values REPEATER∥An and Ks are loaded into the B register and the K register, respectively, of the block module 52.

2-b) 48 clocks are supplied to the block module 52.

2-c) A new frame key Kᵢ[83:0] is generated in the B register of the block module 52.

FIG. 2D shows the operating state when the first calculation module 30 outputs the data Rᵢ and Mᵢ in the third authentication.

2-d) The frame key Kᵢ[83:0] generated in the immediately preceding step is loaded into the K register of the block module 52.

2-e) The value REPEATER∥Mᵢ₋₁ is loaded into the B register of the block module 52. Mᵢ₋₁ represents the M value generated for the immediately previous frame.

2-f) The LFSR module 50 is initialized using the new frame key Kᵢ[55:0].

2-g) The Rekey signal is enabled, and 56 clocks are supplied to the LFSR module 50 and the block module 52. The output unit 54 generates the code Mᵢ during the last four clocks, and generates rᵢ′ during the last two clocks. The data Mᵢ and rᵢ′ thus generated are stored.

2-h) The Rekey signal is disabled.

The first calculation module 30 repeatedly executes the steps 2-a) through 2-h) independently for each port. Every time the variant i becomes a multiple of 128, the output unit 54 outputs the data rᵢ as the authentication data Rᵢ, and instructs the register 22 to store the data Rᵢ thus output.

In a case in which the calculation target is the active port, the values of all the nodes in the LFSR module 50 included in the first calculation module 30 and the values stored in the B register and the K register of the block module 52 are input to the LFSR module 51 and the block module 53 of the second calculation module 32. These values correspond to the aforementioned parameter S3.

With regard to the active port, the second calculation module 32 receives the parameter S3 from the first calculation module 30, and performs calculation processing related to hdcpStreamCipher and hdcpRekeyCipher. Specifically, the second calculation module 32 performs the following processing.

(II) hdcpStreamCipher

FIG. 2E shows the state of the second calculation module 32 when it performs the processing related to hdcpStreamCipher.

3-a) The decoder 12 supplies the signal ENC_EN which indicates that the next frame is configured as an HDCP-encrypted data stream.

3-b) The second calculation module 32 receives, from the first calculation module 30, the parameter S3, which is, specifically, the values of all the nodes included in the LFSR module 50 and the values stored in the B register and the K register included in the block module 52, and copies this data to a corresponding block included in the second calculation module 32.

3-c) When video data or packet data is input, the second calculation module 32 instructs the LFSR module 51 and the block module 53 to operate at the rate of the pixel clock PLL_CLK such that the output unit 55 generates the decipher code S2 as 24-bit pseudo-random data, and outputs the decipher code S2 thus generated to the decryption module 40.

(III) hdcpRekeyCipher

FIG. 2F shows the state of the second calculation module 32 when it performs processing related to hdcpRekeyCipher.

4-a) The second calculation module 32 operates the LFSR module 51 and the block module 53 for 56 cycles at the rate of the pixel clock PLL_CLK.

The above is the configuration of the decipher code generating unit 26.

The register 22 stores the authentication data Rᵢ calculated by the first calculation module 30 for each port. The DDC interface unit (authentication processing unit) 14 performs authentication processing between itself and an external device using the authentication data Rᵢ stored in the register 22.

Returning to FIG. 1, the decryption module 40 uses the decipher code S2 received from the decipher unit 20 to decrypt the encrypted video data or packet data (data stream) S1 received from the decoder 12. Specifically, the decryption module 40 calculates the exclusive OR (ExOR) of the data stream S1 and the decipher code S2 so as to decrypt the data stream S1.

Data S4 thus decrypted by the decryption module is output from the output terminal P_{OUT} via the output interface unit 42.

The above is the configuration of the interface circuit 100.

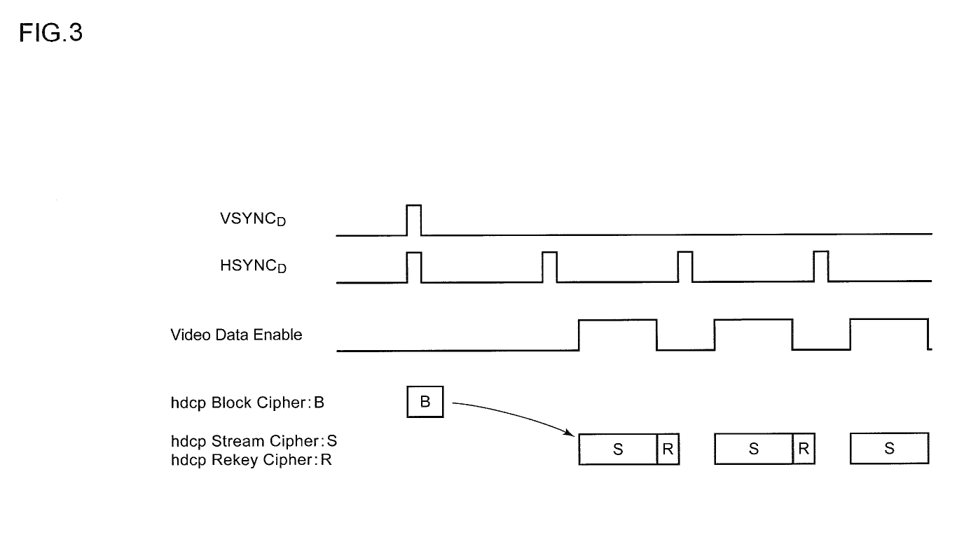

Next, description will be made regarding the operation thereof. FIG. 3 is a time chart related to the active port of the interface circuit 100 shown in FIG. 1.

A vertical synchronization signal VSYNC is asserted for every frame. Subsequently, a synchronization signal ENC_EN is asserted 528 pixel clocks after the vertical synchronization signal VSYNC is asserted. When the decoder detects the synchronization signal ENC_EN, the first calculation module 30 performs a calculation B related to hdcpBlockCipher so as to calculate the data rᵢ. The parameter S3 obtained in this step is supplied to the second calculation module 32. The second calculation module 32 receives the parameter S3, and executes, during the data segment, a calculation S related to hdcpStreamCipher at a pixel clock rate. Furthermore, during a blank period after the video data segment for every line, the second calculation module 32 executes a calculation R related to hdcpRekeyCipher.

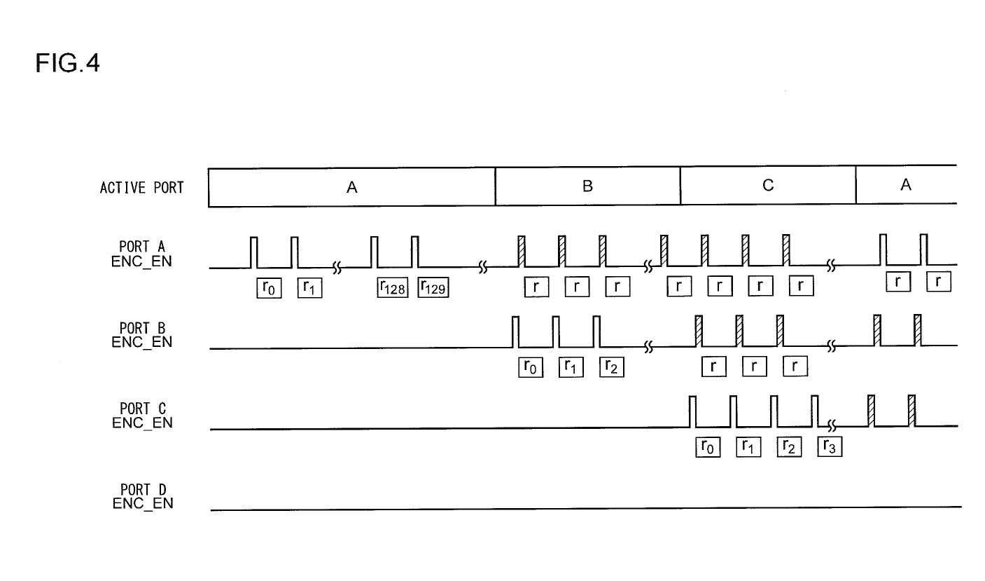

FIG. 4 is a time chart which shows an authentication operation for multiple ports of the interface circuit 100 shown in FIG. 1.

Let us say that, in the initial state, the port A is set to be the active port, and the other ports B through D are each set to be inactive ports. With regard to the active port A, the synchronization signal ENC_EN_{A} is output from the decoder 12 so as to sequentially generate the data r₀, rᵢ and so forth. This establishes and maintains a link between the port A and the external device. With regard to the other ports, i.e., the ports B through D, such authentication data rᵢ is not generated, and accordingly, such a link is not established. During the period in which the port A is active, the synchronization signal generator 60_{A} acquires and holds a parameter of the synchronization signal ENC_EN_{A}. In this state, the synchronization signal generator 60_{A} can generate the emulated synchronization signal ENC_EN_{A}′ for the port A.

Next, let us say that the port B is switched to be the active port. In this case, a synchronization signal ENC_EN_{B} is output from the decoder 12 for every frame for the port B so as to sequentially generate the data r₀, r₁, and so forth. This establishes and maintains a link between the port B and the external device. Furthermore, the synchronization signal generator 60_{B} acquires and holds the parameter of the synchronization signal ENC_EN_{B}. In this state, the synchronization signal generator 60_{B} can generate the emulated synchronization signal ENC_EN_{B}'.

In this period, the synchronization signal generator 60_{A} generates the emulated synchronization signal ENC_EN_{A}′ for the port A using the parameter thus obtained. In this drawing, each emulated synchronization signal ENC_EN_{A}′ is hatched, so that it can be distinguished from the synchronization signals (not hatched) received from the decoder 12. The port A is set to be an inactive port. However, the emulated synchronization signal ENC_EN_{A}′ is asserted for every frame, whereby generation of the authentication data rᵢ continues. This allows a link to be maintained between the port A and the external device connected to the port A.

Next, let us say that the port C is switched to be the active port. In this state, a link is also established and maintained between the port C and an external device. During this period, the synchronization signal generators 60_{A} and 60_{B} continuously generate the emulated synchronization signals ENC_EN_{A}′ and ENC_EN_{B}', respectively. This allows the links to be maintained between the ports A and B and the respective external devices.

Next, let us say that the port A is switched to be the active port. In this stage, the link between the port A and the external device has already been established. Accordingly, there is no need to perform authentication again. Thus, such an arrangement allows the content data to be deciphered immediately after switching the active port.

The above is the operation of the interface circuit 100.

With the interface circuit 100, by providing a module (first calculation module 30) configured to perform calculation processing for every frame and a module (second calculation module 32) configured to perform calculation processing for the active port for every pixel, such an arrangement is capable of decrypting encrypted data input to the active port while maintaining the links established between all the ports and the respective external devices.

The advantages of the interface circuit 100 according to the embodiment can be clearly understood by comparing it with the technique described in Patent document 1. With the technique described in Patent document 1, a calculation module (engine) is arranged for each port, and the calculation module provided for each port executes operations related to all of hdcpBlockCipher, hdcpStreamCipher, and hdcpRekeyCipher. Accordingly, the number of calculation modules required is proportional to the number of ports.

In contrast, with the interface circuit 100 according to the embodiment, such an arrangement requires only two calculation modules even if the number of ports is increased. Thus, such an arrangement provides a dramatic reduction in the circuit area.

Furthermore, once a given port is set to be the active port, the synchronization signal generator 60 generates the emulated synchronization signal ENC_EN′ for that port after the port is switched from being the active port to being an inactive port, thereby allowing a link to be maintained between this port and the external device. As a result, there is no need to perform authentication again when this port is again set to be the active port, thereby allowing image data or audio data to be output immediately after the active port is switched.

Description has been made regarding the present invention with reference to the embodiments. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

Description has been made in the embodiment regarding an arrangement including a single output port P_{OUT}. However, the present invention is not restricted to such an arrangement. Also, the present invention may be applied to an arrangement including multiple output ports P_{OUT}. In this case, the decoder 12 and the selector 10 should be arranged for each output port.

While the preferred embodiments of the present invention have been described using specific terms, such description is for illustrative purposes only, and it is to be understood that changes and variations may be made without departing from the spirit or scope of the appended claims.

1. An interface circuit comprising:
a plurality of ports connected to respective external devices, each including an input port configured to receive, as input data, an encrypted data stream from a corresponding external device, and an authentication port configured to transmit/receive a signal required to perform authentication between it and the corresponding external device;
a selector configured to select the data stream input to an active port among the plurality of input ports;
a decoder configured to receive the data stream input to the active port selected by the selector, and to extract a synchronization signal;
a plurality of synchronization signal generators arranged for the plurality of respective ports, each configured to cyclically generate a synchronization signal for a corresponding port after it receives a synchronization signal for the corresponding port from the decoder;
a first calculation module configured such that, when the synchronization signal extracted by the decoder is asserted for the active port, or when the synchronization signal generated by the synchronization signal generator is asserted for an inactive port, it calculates authentication data used to establish and maintain a link between the port and the corresponding external device;
a second calculation module configured such that, when the synchronization signal is asserted for the active port, it generates a decipher code used to decipher the data stream input to the active port, using data obtained by the calculation processing of the first calculation module;
a decryption module configured to decrypt the data stream input to the active port selected by the selector, using the decipher code output from the second calculation module; and
an authentication processing unit configured to maintain a link between each port and the corresponding external device, using the authentication data calculated for the corresponding port by the first calculation module.

2. An interface circuit according to claim 1, wherein the data received from the external device includes at least image data,
and wherein the first calculation module is configured to execute calculation processing for every frame,
and wherein the second calculation module is configured to execute calculation processing for every pixel.

3. An interface circuit according to claim 1, wherein the first calculation module comprises an LFSR module, a block module, and an output unit.

4. An interface circuit according to claim 3, wherein the second calculation module comprises an LFSR module, a block module, and an output unit,
and wherein the LFSR module of the second calculation module is configured to receive data from the LFSR module of the first calculation module,
and wherein the block module of the second calculation module is configured to receive data from the block module of the first calculation module.

5. An interface circuit according to claim 1, wherein the decoder comprises:
a de-serializer configured to receive the data stream from the active port in the form of serial data, to reproduce a PLL clock, and to convert the data stream into parallel data;
a format converter configured to decode an data stream subjected to 8b/10b encoding; and
a TMDS decoder configured to extract a horizontal synchronization signal, a vertical synchronization signal, video data, packet data, and a synchronization signal, from the data stream input via the active port.

6. An electronic device comprising an interface circuit, wherein
the interface circuit comprises:
a plurality of ports connected to respective external devices, each including an input port configured to receive, as input data, an encrypted data stream from a corresponding external device, and an authentication port configured to transmit/receive a signal required to perform authentication between it and the corresponding external device;
a selector configured to select the data stream input to an active port among the plurality of input ports;
a decoder configured to receive the data stream input to the active port selected by the selector, and to extract a synchronization signal;
a plurality of synchronization signal generators arranged for the plurality of respective ports, each configured to cyclically generate a synchronization signal for a corresponding port after it receives a synchronization signal for the corresponding port from the decoder;
a first calculation module configured such that, when the synchronization signal extracted by the decoder is asserted for the active port, or when the synchronization signal generated by the synchronization signal generator is asserted for an inactive port, it calculates authentication data used to establish and maintain a link between the port and the corresponding external device;
a second calculation module configured such that, when the synchronization signal is asserted for the active port, it generates a decipher code used to decipher the data stream input to the active port, using data obtained by the calculation processing of the first calculation module;
a decryption module configured decrypt data stream input to the active port selected by the selector, using the decipher code output from the second calculation module; and
an authentication processing unit configured to maintain a link between each port and the corresponding external device, using the authentication data calculated for the corresponding port by the first calculation module.
